(19) United States
(12) Patent Application Publication
(10) Pub. No.: US 2011/0273482 A1
(43) Pub. Date: Nov. 10, 2011

(54) METHOD FOR PROCESSING AN IMAGE IN A DISPLAY

(76) Inventors: Mathieu Massart, Gent (BE); Tom Kimpe, Gent (BE); Tom Bert, Lochristi (BE)

(21) Appl. No.: 13/054,231

(22) PCT Filed: Jul. 15, 2009
(86) PCT No.: PCT/EP2009/059097

§ 371 Date: Jul. 20, 2011

(30) Foreign Application Priority Data
Jul. 15, 2008 (EP) 08160468.8

(51) Int. Cl. G09G 5/10

(52) U.S. Cl. 345/690

(57) ABSTRACT

The invention relates to a method for processing an image, adapted for a display comprising a plurality of pixels, comprising the steps of setting, in dependence upon the image content, a portion out of the plurality of pixels to black for obtaining off-pixels thereby reducing the resolution of the display to a predefined value; and sequentially switching the position of the off-pixels over the plurality of pixels comprised by the display. In this way, a possibility for reducing or compensating for image retention in displays is provided.

### FIELD OF THE INVENTION

The invention relates to the field of systems, devices and methods for processing an image, adapted for a display comprising a plurality of pixels.

### BACKGROUND OF THE INVENTION

It is generally known that image persistence, image burn-in and image sticking are terms used to describe image retention in liquid crystal displays (LCDs), in plasma displays, OLED displays and also in other kind of displays. A user commonly recognizes image retention when a fixed pattern is displayed over a prolonged period of time. For instance, in LCDs the fixed pattern causes the build-up of parasitic capacitance within the LCD component, which causes a difference between the intended pixel value and the real value on the screen or the panel, respectively. Hence, image retention reduces image quality and is responsible for a plurality of customer complaints.

Due to the growth in size and the reduction in price, LCDs and also other direct view display technologies have entered new application areas where they are even more prone to retention artifacts. For instance, in a twenty-four hours a day, seven days per week-operation (24/7-operation, in short) and in control room applications the reduction or even prevention of retention artifacts is essential. It goes without saying that both the context of use in a continuous operation and the image type, whereby the image is subdivided into different zones, make it very important to reduce or even prevent image retention. It is important to overcome this problem quickly, meticulously and reproducible since LCD systems are going to be introduced in such applications.

The causes of image retention lie with the panel manufacturers. However, even with improved materials and production techniques, the causes inside the panel will not disappear completely, even not in long term.

In US 2008/0074568 A1 an LCD device is disclosed. It includes an LCD panel, an area light source device which illuminates the LCD panel, a driving unit which drives the LCD panel and the area light source device, and a control unit which controls the driving unit. The LCD panel includes display pixels. The area light source device includes a plurality of light sources which are successively turned on in one frame period. Further, the control unit includes means for controlling the driving unit in a manner to execute video signal write and reset signal write after the video signal write, in a period in which one of the plurality of light sources is turned on in the one frame period. The video signal write and the reset signal write are executed with the same polarity, and a plurality of potential of the display pixels is reversed between frame periods.

However, the prior art discloses merely too sophisticated solutions for reducing image retention or mostly unreliable and inaccurate approaches. Further, the problem of image retention still appears in some documents since it is not completely compensated for, or even not reduced to a certain extent. To sum up, methods and algorithms for image processing to reduce image retention exist. Most of them rely on adapting the image in a way invisible to a user.

Other approaches to reduce image retention in display applications are summarized in the following: A first possibility would be to display the specific content at a moment when the user is not looking, e.g. at night, when no users are sitting in front of the screen, which can also be possible in other situations. This approach is not appropriate in applications where 24/7-operation is crucial. Furthermore, in a multi-viewer setup, such as in control room applications, it is impossible to figure out at which moment in time nobody is looking at the screen, provided such a moment exists at all. A second possibility is making some areas of the screen invisible. In LCDs this can e.g. be done by switching off the backlight. However, this second possibility is not well suited for LCDs because it relies on processes working at a completely different time scale than the sources of image retention. Typically the frame rate of a 60 Hz screen is 16.6 ms; where diffusion time constants for charged contaminations at the origin of image retention is on the order of some minutes. A third possibility is orbiting the content. In other words, moving the complete image without altering the small scale features of the image provides a third possibility to reduce image retention. It has been a long time that this approach has been implemented in cathode ray tubes (CRTs) by slowly orbiting the complete image around its centre. This third possibility can be applied in LCDs but, however, does not provide the optimum solution.

It is noted that image retention is due to the poor removal of the DC component in the driving voltage. The DC component can only disappear completely in a black pixel. Altering the pixel content by orbiting usually slows down the image retention when preventing a pixel value being constantly at its maximum. The pixel value cannot cure or recover, respectively, because the value will not be equal to zero. Furthermore, the shift of the orbiting has to be bigger than the pixel blocks being shown on the screen or panel, respectively. For instance, a 100×100-pixel white block will have to orbit more than 100 pixels. Therefore, orbiting works only well for black backgrounds with thin lines.

### SUMMARY OF THE INVENTION

It is an object of the present invention to provide systems, devices and methods for processing an image, adapted for a display comprising a plurality of pixels.

An advantage of the present invention is that it can provide an accurate and reliable possibility for reducing image retention in display applications without performing changes to the panel itself.

This object is achieved by a method for processing an image, adapted for a display comprising a plurality of pixels, first image values being definable for the plurality of pixels to display an arbitrary image, the method comprising the steps:

a) setting a portion out of the plurality of pixels to second image values that are lower than the first image values, that is the second image values are different values to reduce the image retention, the second image values being darker or are black for obtaining off-pixels; and
b) sequentially switching the position of the pixels driven by different values to reduce the image retention over the plurality of pixels comprised by the display.

Preferably the setting of the portion is done in dependence on the type of content being displayed. The setting, depending on the type of content being displayed, preferably includes setting depending upon dominantly dynamic or static image content.

Such a method for processing an image is adapted for a display comprising a plurality of pixels N, first image values being definable for the plurality of pixels to display an arbitrary image. Normally the full number of N pixels is used to display an arbitrary image. However in accordance with the present invention a portion, e.g. M out of the plurality of pixels N are set to second image values that are lower than the first image values, that is the second image values are different values to reduce the image retention, e.g. are darker or are black for obtaining off-pixels. The effect of this is that there are N-M pixels for display of an arbitrary image on the display, i.e. the resolution of the displayed image is reduced to the predefined value determined by the number of pixels N-M. Further the step of sequentially switching the position of the off-pixels over the plurality of pixels of the display while displaying the arbitrary image is preferably done so the pixels with the second image values are in a regular array.

With “reducing the resolution of the displayed image to the predefined value” is meant that the input resolution of the display is reduced to a predefined value. The effective display resolution (the number of pixels present in the panel) remains the same. Hence, the number of pixels used to display the required image is reduced as some of the pixels present in the panel are set to the different value, i.e. darker or black, for the purpose of image retention curing.

Accordingly, it is an important idea of the invention to provide a method for processing an image that will adapt the content of the panel or screen, respectively, in a way that over a long term period image retention is reduced or even compensated for. Preferably how this adaptation is done depends on the type of content being displayed, i.e. depending upon dominantly dynamic or static image content.

It is worth noting that the method can be applied at a receiver side of a display system, wherein the receiver unit is preferably arranged inside the display system or also at the image generator side of a display system. Furthermore, it is worth noting that the processing of the image can be done invisibly to the user by switching the position of the second image values that are lower than the first image values, that is the different values to reduce the image retention, e.g. darker pixels or black pixels in such a way that these are invisible to the human visual system. For example, the changes in the image can be made invisible to a person with 20/10 vision at a distance of 1 metre. Visibility of the pixels driven by the second image values that are lower than the first image values, that is different values to reduce the image retention, e.g. darker pixels or black pixels can also be reduced by altering the contents of the pixels in the neighbourhood of the introduced pixels driven with different values (e.g. darker or black pixels) in such a way that this altering will reduce the visibility of the pixels driven with different values (e.g. darker or black pixels) for the human visual system.

Moreover, this object is achieved by a display comprising a panel, a light source device for illuminating the panel, a driving unit for driving the panel and the light source device, and a control unit for controlling the driving unit, wherein the control unit comprises code means adapted for performing the steps of the method described above.

The method makes use of the fact that in most applications overkill in the number of available pixels is present in a CRT or a fixed format display such as an LCD, plasma, OLED or LED display. For instance, in large area applications high definition displays can and will be used with a pixel size below 1 mm. However, in several setups, the viewing distances are such that the visual acuity makes it impossible to recognize details below 1 mm. In other words, one can artificially reduce the resolution of the display, e.g. by image processing, to a predefined value where the average pixel size is of the order of what a user or viewer, respectively, still is able to recognize. This resolution headroom is used in embodiments of the present invention to overlay retention-curing content on the screen. For instance, a predefined value of the resolution of the display corresponds to an image, whereby the user can still recognize this image shown on the display. This image may be such that a person with 20/10 visual acuity can detect elements of the image at 1 metre. The predefined value of the resolution of the display is used when the retention-curing content on the screen is overlaid with the real content. In other words the total number of pixels provided by a display that are available for displaying an arbitrary image is reduced by the number of pixels that are to be set to a retention-curing value, e.g. darker or black. The remaining pixels are available for displaying an arbitrary image. Preferably the pixels left for display of the image are in a regular array.

With respect to the step of resolution reduction, at least three ways may be used to determine which resolution should be used:

1) based on the loss of contrast or luminance: the pixels with different values, e.g. the darker or more black pixels are introduced (and therefore the larger the kernel becomes, and the lower the resolution of the display becomes) the lower the peak luminance and large area contrast becomes. There is a minimum contrast/luminance that is needed, so it is preferred that this a minimum contrast/luminance determining the minimum resolution that can be accepted.
2) based on the effectiveness of the image retention reduction/curing algorithm. The more pixels with the different values e.g. dark or black pixels are introduced, the higher the percentage that every pixel in the display is dark or off, and therefore the longer it will take before image retention appears (or the quicker image retention is healed). Based on running time per day and the time needed to cure image retention, one can determine the percentage off-time for every pixel that is needed. That determines at least approximately the kernel size and therefore the resolution.
3) Based on the resolution that a human observer can see from the normal working distance for the display being used. The visual acuity will determine what resolution can be perceived at normal working distance.

The method according to the invention provides a reliable, accurate and fast possibility for processing an image in a display, regardless of the kind of display, in order to reduce image retention. Preferred embodiments are described in the sub claims.

According to a preferred embodiment of the invention, in step a) of the method the image displayed on the display is preferably further softened by applying a smoothing or softening algorithm on a plurality of pixels displaying the image. Preferably, the smoothing or softening algorithm is applied to regions of the image that are static as changing pixels in static regions to allow retention curing can be seen more easily. Further it is preferred if the smoothing or softening algorithm is applied to regions of the image that have been static for more than 10 seconds. In particular, it is preferred if the smoothing or softening algorithm is applied to lines or edges in the image that have been static for more than 10 seconds. Changes in lines or edges can be seen easily by the eye, hence if these can be softened changes are less visible. In this way, image retention are not only reduced but almost compensated for. Sharp edges or lines in the image (that need to be displayed) are preferably smoothed to avoid abrupt changes e.g. that there are abrupt changes from black to white, i.e. contrast jumps. Sharp edges or lines in an image can result in lateral image retention, which is to be avoided because it has the lowest threshold for occurrence and visibility.

The resolution used to display an arbitrary image (=the total number of pixels available minus the pixels that have been made darker or black for retention curing) preferably corresponds to a minimum resolution of the display that is adapted for a user to recognize a change in the image. A minimum change in the image is preferably recognisable by a person with 20/10 visual acuity at 1 metre, for example. The human eye is better at recognizing sharp luminance gradients, i.e. sharp edges, in the image compared to recognizing the difference between two distant surfaces. Therefore, edges or contrast jumps are preferably softened because these are the areas where image retention will be most visible to the human eye and thus to the user. In particular static edges or contrast jumps are preferably softened because these are the areas where image retention changes will be most visible to the human eye and thus to the user. In particular static edges or contrast jumps are preferably softened that have been static for at least 10 seconds.

Further, according to yet another preferred embodiment of the invention, step a) can be dynamically adapted based on e.g. the position or viewing distance of the user(s), the type of content being displayed (e.g. dominantly dynamic or static content), the current lifetime of the display and/or panel, the temperature of the panel or temperature of the environment, the humidity in the neighbourhood of the panel or the humidity of the environment, . . .

Further, according to yet another preferred embodiment of the invention, step a) can applied independently for different regions on the display. E.g. if one region on the display is showing static image content then a resolution reduction of e.g. a factor 4 could be applied, another region on that same panel could e.g. show dynamic content and e.g. a resolution reduction of a factor 2 could be applied.

Further, according to yet another preferred embodiment of the invention, step b) of the method corresponds to changing, e.g. translating, expanding, orbiting or rotating the position of the pixels driven by different values, e.g. dark, black or off-pixels at a predefined frequency or frequencies or at a dynamically set frequency or frequencies. In other words, the changing, e.g. translating, expanding, orbiting or rotation is preferably performed over a time period at a certain rate thus resulting in a frequency of making such changes. The selected frequency preferably corresponds to a low frequency adapted for reducing at least one of image retention, image sticking and image burn-in. The present invention is not restricted to a predetermined static frequency of adapting the position of the pixels driven by different values, e.g. dark, black or off-pixels. This frequency can change over time or can include a summation of several frequencies. Alternatively the algorithm to decide when and how position of the pixels driven by different values, e.g. dark, or black pixels is changed, can be more complex and can for example be based on a random generator. Alternatively, the location of the pixels driven by different values, e.g. dark, or black pixels can be changed based on the image contents. When there are large changes in the image contents then also changes of the location of the pixels driven by different values, e.g. dark, or black pixel location will be more difficult to detect by human users. Alternatively, the location of the pixels driven by different values, e.g. dark, or black pixels can be changed based on e.g. the position or viewing distance of the user(s), the type of content being displayed (e.g. dominantly dynamic or static content), the current lifetime of the display and/or panel, the temperature of the panel or temperature of the environment, the humidity in the neighbourhood of the panel or the humidity of the environment, . . .

In a particularly preferred embodiment, the pixel values are changed by fading out to the darker or black value and by fading in to the image value relevant for that pixel. The fading in and/or out preferably takes place slowly over a period of at least 1 second or more preferably of at least 3 seconds and preferably less than 60 seconds, especially in areas of static content, e.g. those static for more than 10 seconds. In particular the rate at which the pixels change in different parts of the image can be varied randomly within the overall time frame of at least 1 second or more preferably of 3 to 60 seconds. For example, all the pixels may fade in or out over a 3 second time period but the start time is selected randomly at time above 1 second or more preferably within the 3 to 60 seconds for different pixels that will be switched from displaying the image to image retention curing or vice versa. Instead of the start time or in addition to the start time the duration of the fade in or fade out can be varied randomly over the pixels that are going to be changed, i.e. the duration can be varied randomly for different pixels at a time larger than 1 second or more preferably between 3 and 60 seconds. In this way not all of the pixels change at the same time. In this way the changes are gradual and less easily observed by the eye.

Preferably, the display corresponds to an LCD. In general, it is possible that the display also corresponds to one of a plasma display, an organic light emitting diode (OLED) display and a CRT display. Furthermore, the method is preferably used at a receiver side in a display system, preferably arranged inside the display system, and/or at an image generator side.

Finally, it is worth noting that methods according to embodiments of the present invention can reduce or almost completely compensate for image retention, image sticking and image burn-in without visibility of the process of retention curing. This is highly desirable in applications such as 24/7-operation, in control rooms, airports, point of sales, advertising etc.

The present invention also provides a display comprising a panel, a light source device for illuminating the panel, a driving unit for driving the panel and the light source device, and a control unit for controlling the driving unit, wherein the control unit comprises code means adapted for performing the steps of the method according to any of the methods of the present invention, e.g.

a) setting a portion out of the plurality of pixels to second image values that are lower than the first image values, that is the second image values are different values to reduce the image retention, the second image values being darker or are black for obtaining off-pixels;
and
b) sequentially switching the position of the pixels driven by different values to reduce the image retention over the plurality of pixels comprised by the display.

Preferably the setting of the portion is done in dependence on the type of content being displayed. The setting, depending on the type of content being displayed, preferably includes setting depending upon dominantly dynamic or static image content.

The present invention also includes a control unit for use with a display comprising a plurality of pixels, comprising:

a) means for setting a portion out of the plurality of pixels to different values to reduce the image retention, i.e. to darker or black for obtaining off-pixels;
b) means for sequentially switching the position of the pixels driven by different values to reduce the image retention, i.e. darker or black or off-pixels over the plurality of pixels comprised by the display.

Preferably the means for setting of the portion is adapted to set in dependence on the type of content being displayed.

The present invention includes a computer program product comprising code segments adapted, when executed on a computing device, for performing the steps of the method according to the present invention or for implementing an apparatus according to the present invention.

The computer program product may be stored on a machine readable signal medium such as a diskette, a solid state memory such as a USB memory stick or RAM, a hard drive, a tape storage means, an optical disk such as a CD-ROM, or DVD or any other suitable digital storage means.

### BRIEF DESCRIPTION OF THE DRAWINGS

These and other aspects of the invention will be apparent from and elucidated with reference to the embodiments described hereinafter.

In the drawings:

FIGS. 1 a-d illustrate schematically an edge of a display panel comprising a portion out of a plurality of pixels, whereby the position of the off-pixels is sequentially switched according to a first embodiment of the invention.

FIG. 2 illustrates schematically a display according to another embodiment of the invention.

### DETAILED DESCRIPTION OF EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps.

Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

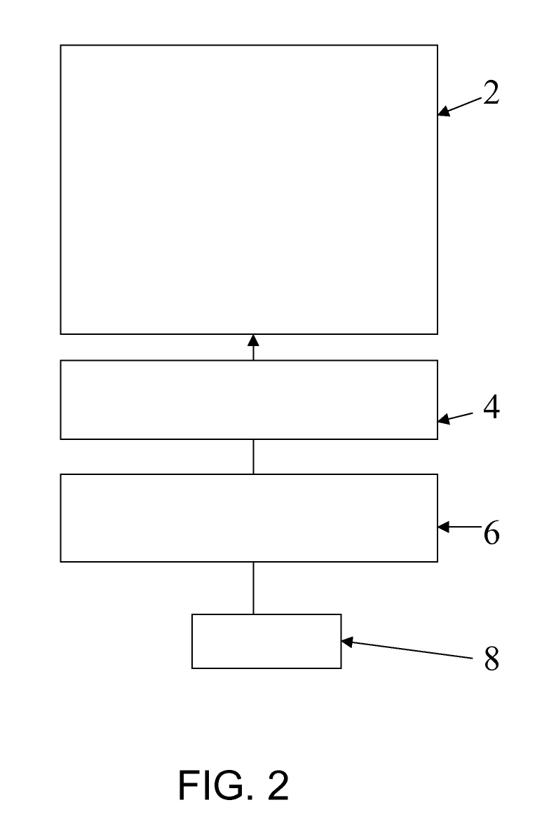

FIG. 2 is a schematic representation of a display system including a signal source 8 a controller unit 6, a driver 4 and a display 2 with a matrix of pixel elements 10 that are driven by the driver 4.

In the following reference will be made to a method, system or controller for processing an image, adapted for a display comprising a plurality of pixels, first image values being definable for the plurality of pixels to display an arbitrary image. Under normal conditions the pixels would be driven with the first image values to display the arbitrary image. However in accordance with embodiments of the present invention some of the pixels are driven with different values, e.g. to form dark, black or off-pixels, in order to reduce image retention while still displaying the arbitrary image. Dark pixels may be set to a low level, e.g. if there are 255 grey scale values a dark pixel is set to a value of less than 10 or other value. Alternatively a dark pixel may be one set to a value below the first image value, e.g. 10 grey scale values below the first image value. This means that the number of pixels available to reproduce the image is reduced compared to the total number of pixels available from the display itself. Thus, the apparent resolution of the image is reduced because there are less pixels involved in displaying the image. The number of pixels for displaying the image is the total number available for the complete display minus the number that take a different value to reduce retention, i.e. take a dark value such as black. As the number set to a different value to reduce retention, i.e. set to a dark value is known, then the apparent resolution of the image is predefined.

In accordance with all or any of the embodiments of the present invention, it is preferred if the pixel values set to a different value to reduce retention, i.e. those set to a dark value are in a regular array. However, it is preferred if the pixel values set to a different value to reduce retention do not lie in a line along contiguous lines either vertical horizontal or diagonal.

For example imagine a part of a display with 4×4 or 16 pixels having the pixel values as shown below.

| | | | |
|---|---|---|---|
| 0 | 15 | 4 | 3 |
| 7 | 5 | 6 | 2 |
| 14 | 10 | 9 | 15 |
| 11 | 8 | 5 | 0 |

The table above represents a display with 4×4 physical pixel or light valves that can be actuated independently from each other (symbolized by FIGS. 0-16 in the cells of the table above which represent different grey-scale values from black (0) to white (16)).

In accordance with the present invention there is a reduction in the input resolution of the display means by certain pixels, preferably being part of a regular array, being forced to display a dark value. In the example below it has been arbitrarily selected that some of the values will display the retention curing value black=0. In this way the distance between two pixels that are displaying a part of the arbitrary image has been increased on average, i.e. the average resolution has been reduced.

| | | | |
|---|---|---|---|
| 0 | 15 | 4 | 0 |
| 7 | 5 | 6 | 2 |
| 14 | 10 | 9 | 15 |
| 0 | 8 | 5 | 0 |

In the table above the second pixel in the first row cannot be set to zero because it would form a contiguous line of black pixels with the first pixel. The first and second pixels in the second row cannot be set to zero (black) as they would form a contiguous line with the first pixel in the first row. The same is true for the third and fourth pixels in the third row and the third pixel in the fourth row. The third pixel in the first row could be set to zero but this is possibly a non-optimum solution. The fourth pixel in the first line is set to black as is the first pixel in the fourth row. By this means a regular array of black pixels is obtained as the first pixel in the first row and the last pixel in the fourth row are black and hence contribute to image retention curing array.

By making the pixels involved in image retention into a regular array reduces the frequencies present in a Fourier analysis of the changed image—these lower frequencies are less visible to the user. This is true for instance for a user with 20/10 visual acuity when viewing the display at 1 metre.

In embodiments of the present invention an algorithm is used that optimises the selection of those pixels that will be changed in value such that image retention is cured. The changes are preferably made at a low rate, i.e. at a low frequency so that there is sufficient time to run these algorithms in real time.

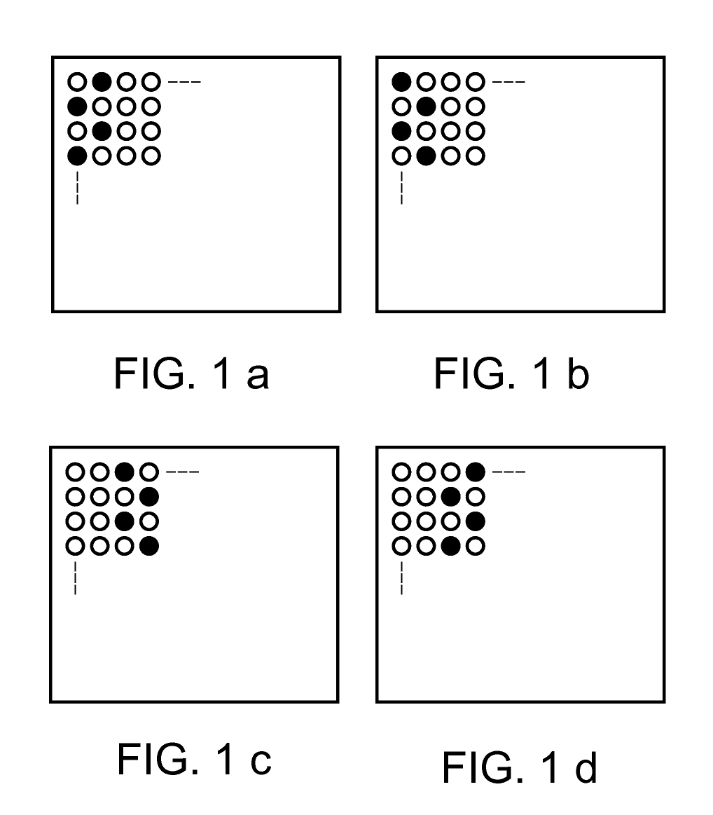

FIGS. 1 a to d show an embodiment of the present invention. In these figures a schematic illustration of a display panel comprising a portion out of a plurality of pixels is shown, whereby the position of pixels driven by different values, e.g. dark, black or off-pixels, is sequentially switched. The setting of the pixels to the different values, e.g. darker or black is preferably done depending on the type of content being displayed in the image. Particularly important is to distinguish between static and dynamic areas of the image. If the image is varying rapidly then changes from image values to darker values used for image retention curing may go unnoticed. On the other hand, changes taking place in generally static parts of the image may be noticed easily. Particularly, changes in or close to sharp edges or lines in an image can be more easily seen, especially where these are static. Hence in accordance with embodiments of the present invention the position in the image of changes from image values to values that are darker or black and are used for image retention curing are selected based on the image content especially based on whether the image is static or dynamic. Parts of the image that have been static for more than 10 seconds are particularly likely to have image retention so that it is in these areas that image retention curing should be carried out. However such changes are easier to detect in these areas.

One solution to this problem, is to make the changes in the pixel values by fading in or fading out over a time period. The fading in or fading out is preferably performed over a time period of at least 1 second or more preferably of at least 3 seconds and less than 60 seconds. In particular the rate at which the pixels change in different parts of the image can be varied randomly within the overall time frame of at least 1 second or more preferably of 3 to 60 seconds. For example, all the pixels may fade in or out over an at least 1 second or more preferably of a 3 second time period but the start time is selected randomly within the at least 1 second time period or more preferably 3 to 60 seconds. Instead of the start time or in addition to the start time the duration of the fade in or fade out can be varied randomly over the pixels that are going to be changed. In this way not all of the pixels change at the same time. This slows down the changes and makes the changes less easy to see in areas of the image that are static. Surprisingly it has been found that slow changes caused by fading in and fading out do not make the changes more visible in areas of the image that are changing rapidly. Optionally, in accordance with embodiments of the present invention, selection of pixels to have their values changed such as to provide retention curing are selected based on the image content especially whether the image is static or dynamic. For static areas, the pixel values are preferably changed by fading in and fading out over a time period of at least 1 second or more preferably of 3 to 60 seconds. The start times and/or duration of fading may be varied, e.g. randomly within the image. In areas of dynamically changing content, the pixels can be faded in and out in the same way or they can be changed at a more rapid rate, for example.

FIGS. 1 a to 1 d schematically represent the evolution of the position of the pixels driven by different values, e.g. dark, black or off-pixels over time. In this respect, FIG. 1 a shows the first point in time, FIG. 1 b the second position in time etc.

Sequentially switching refers to changing the position, e.g. translating such as laterally moving, rotating the position of the pixels driven by different values, e.g. dark, black or off-pixels or orbiting them or expanding over a plurality of pixels during a certain time period. Preferably at each time period all the pixels involved in curing image retention are in a regular array. Preferably the changes in the pixel values is achieved by fading in or fading out over a time period of at least 1 second or more preferably of at least 3 seconds and less than 60 seconds, especially in areas of static content, e.g. static for more than 10 seconds. The start times and/or duration of fading may be varied, e.g. randomly within the image. In areas of dynamically changing content, the pixels can be faded in and out in the same way or they can be changed at a more rapid rate, for example. This can achieved in the following way. It is determined for each pixel to be changed from an image value to a value that is darker for image retention curing whether the pixel lies in a static area or in a dynamically changing area of the image. If the pixel is in a static area then it is changed slowly by fading to the darker value slowly over at least 1 second or more preferably over 3 to 60 seconds. The start times and/or duration of fading may be varied, e.g. randomly within the image. If the pixel is in the dynamic part of the image it is changed in the same way by fading in or out or at a faster rate. Thus the pixels being changed are preferably always in a regular array. As the rate of change or the frequency at which changes can be made is determined by the pixel that takes the longest time to change (i.e. the ones involved in fading in or out), the rate of change in accordance with the present invention is set to a low frequency.

In this way, the whole display panel or display screen can be treated. In this first embodiment this is done with a low frequency adapted for reducing image retention, i.e. the rate at which pixel values are changed is slow. In this way, ion diffusion inside a pixel that is responsible for the image retention is given enough time to support the reduction of retention. Thus, retention artifacts are suppressed.

The sequential switching can be done in a randomized manner in this first embodiment, in such a way that the whole screen is completely treated or scanned, respectively. The steps performed on the content of the image that comprises a plurality of pixels are summarized in the following: a portion out of a plurality of pixels is set to different values than those of the first image values, e.g. darker or black for obtaining off-pixels. These pixels driven by different values, e.g. darker or black pixels. Preferably at each time period all the pixels involved in curing image retention are in or part of a regular array. Preferably the changes in the pixel values are achieved by fading in or fading out over a time period of at least 1 second or more preferably of at least 3 seconds and less than 60 seconds, especially in areas of static content, e.g. static for more than 10 seconds. The start times and/or duration of fading may be varied, e.g. randomly within the image. In areas of dynamically changing content, the pixels can be faded in and out in the same way or they can be changed at a more rapid rate, for example. These changes will be invisible to a user when the eye's acuity averages out the pixels driven by different values, e.g. dark, black or off-pixels and the neighbouring on-pixels that correspond to the rest of the plurality of pixels different from the portion out of the plurality of pixels that have been set to different values, e.g. dark or black. The human eye has an effect called hyperacuity. It means that very small structures such as thin lines will be very visible to the eye. It is preferred that the black off-pixels do not form lines. Further, the visibility can be reduced by applying a defective pixel correction algorithm to those pixels still involved in displaying the real image. Such methods are known to the skilled person, i.e. to make the pixels in a dark or off-state less visible, e.g. invisible, i.e. the pixels that are set to black. The changes should preferably be invisible to a person with 20/10 visual acuity at 1 metre.

In other words, the pixels driven by different values, e.g. dark, or black pixels (off-pixels) are not stressed and cure in LCDs as in this first embodiment. In alternative embodiments the number of pixels driven by different values, e.g. dark, black or off-pixels is more or less equal over the entire surface of the display. This can be used to avoid large area flicker due change of average luminance in certain areas of the display surface.

Sharp edges in the image (that need to be displayed) are preferably smoothed to avoid e.g. that there are abrupt changes from black to white. Sharp edges in an image can result in lateral image retention, which is to be avoided. Sharp edges in the image (that need to be displayed) are preferably smoothed or softened if they are static, e.g. they are static for more than 10 seconds. This supports the reduction of image retention and makes image retention invisible to the user. As already described, the human eye is better at recognizing sharp luminance gradients or sharp edges or lines in the image than in recognizing the difference between two distant surfaces. Hence, the edges, lines or contrast jumps in the image displayed on the display are softened. In this first embodiment this is can be done by applying a softening or smoothing algorithm on the image data, because these are the areas where image retention is most visible. Preferably softening or smoothing is done on regions if they are static, e.g. are static for more than 10 seconds. By choosing a lower resolution for the display of the arbitrary image, the lower resolution causes a kind of blurring for a user, such that the user is less able to recognize the loss of detail in an edge in the respective image. In other words, the maximum resolution of the display is not chosen for displaying the arbitrary image. In this way, the overall minimum feature size is reduced to a minimum resolution, in such a way that a user is still able to recognize a change in the image, i.e. a user with 20/10 visual acuity at 1 metre could still be able to recognise changes in the arbitrary image for example.

Finally, the position of the pixels driven by different values, e.g. dark, black or off-pixels is switched sequentially, i.e. the position is switched over time. Preferably, at each time period all the pixels involved in curing image retention are in a regular array. Preferably the changes in the pixel values are achieved by fading in or fading out over a time period of at least 1 second or more preferably of at least 3 seconds and less than 60 seconds, especially in areas of static content, e.g. those static for more than 10 seconds. The start times and/or duration of fading may be varied, e.g. randomly within the image. In areas of dynamically changing content, the pixels can be faded in and out in the same way or they can be changed at a more rapid rate, for example. The pixels driven by different values, e.g. dark, black or off-pixels are the pixels at rest and where the curing is occurring. By sequentially switching is meant changing, such as by translating, expansion, orbiting or rotating, respectively, the position of the pixels driven by different values, e.g. dark, or black pixels the whole screen or panel is performed. The switching is preferably done at a low frequency to give the processes that can cure the retention enough time in order to suppress or reduce artifacts. In other words, the processes that can cure the retention, such as the ion diffusion inside the pixel, are given time to work sufficiently.

In this first embodiment the LCD is run for a long time, e.g. with a stationary image, so that the pixel values have changed. Hence, some of the pixels are set to different values, e.g. black for a while, i.e. for a certain time period, so that they can recover or cure, respectively. If these pixels driven by different values, e.g. dark, black or off-pixels are spread around an image over time, corresponding to changing, e.g. translating, expanding, orbiting or rotating the position of these pixels at a frequency or frequencies, the effect on the image cannot be recognized by the user. The reference user is preferably a user with 20/10 visual acuity viewing the display at 1 metre. The frequency or frequencies may be predefined or selected dynamically. Preferably the changes in the pixel values are achieved by fading in or fading out over a time period of at least 1 second or more preferably of at least 3 seconds and less than 60 seconds, especially in areas of static content, e.g. static for more than 10 seconds. The start times and/or duration of fading may be varied, e.g. randomly within the image. In areas of dynamically changing content, the pixels can be faded in and out in the same way or they can be changed at a more rapid rate, for example. Preferably at each time period all the pixels involved in curing image retention are in a regular array.

In this first embodiment a screen is used with a resolution that is two times higher than a usual resolution. As an example, half of the pixels are on (on-pixels) and show the arbitrary image, the other half is off (off-pixels) and image retention recovery occurs. Then the position of the off-pixels is sequentially switched over the plurality of pixels comprising the on-pixels and the off-pixels, i.e. it is oscillated between the on-pixels and the off-pixels over time. Preferably the changes in the pixel values is achieved by fading in or fading out over a time period of at least 1 second or more preferably of at least 3 seconds and less than 60 seconds, especially in areas of static content, e.g. static for more than 10 seconds. The start times and/or duration of fading may be varied, e.g. randomly within the image. In areas of dynamically changing content, the pixels can be faded in and out in the same way or they can be changed at a more rapid rate, for example. A predefined value for the resolution of the display has been chosen (be using some pixels for image retention curing) to make the movement or change of the image by a pixel not recognizable for a user.

In another preferred embodiment some pixels driven by different values, e.g. dark, black pixels are comprised in the real image to be displayed. This can be done by selecting the pixels driven by different values, e.g. dark, black or off-pixels have to be driven accordingly to provide any black colour in the image to be displayed (see example above).

In yet another preferred embodiment of the invention, the method is used on an LCD panel for a number of pixels driven by different values, e.g. dark, black or off-pixels equal to 75%. The screen brightness is reduced to up to 25% of its maximum value in this embodiment. However, each pixel has at least 75% of the available time to spend on curing or recovering, respectively. Further, the compensation pattern parameters, such as the off-time, depend on the content of the pixels. It is noted that the screen brightness remains high, if e.g. the backlight luminance is increased such that the peak luminance of the display remains the same. Another possibility is to adapt the image contents of pixels in the neighbourhood of the introduced pixels driven by different values, e.g. dark, or black pixels so that the display output luminance remains the same. E.g. if 50% of the pixels are changed in value, e.g. turned off, then it may be possible to increase the digital driving levels of the remaining pixels such that the same luminance output is achieved (without adapting the backlight luminance) as for a display with 0% of the pixels turned off. Of course this is only possible if the remaining pixels are not driven to their maximum value.

Some possible applications of the invention are: displays in control rooms e.g. in airports, displays in point of sales or in advertising. Preferably, the pixel size required in such application is larger than the physical pixel size of the panel.

It goes without saying that the method is applicable on any kind of display technology where image retention occurs. In emissive technologies, such as in plasma display panels (PDPs), in OLEDs or in CRTs image retention will be reduced. The method cures image retention in LCDs, i.e. image retention is almost completely compensated for in LCDs.

The present invention also provides a control unit for use with a display such as one of a liquid crystal display, a plasma display, an organic light emitting diode display and a cathode ray tube display, any of which comprises a plurality of pixels, first image values being definable for the plurality of pixels to display an arbitrary image, the control unit comprising:
a) means for setting a portion out of the plurality of pixels to second image values that are lower than the first image values, that is the second image values are different values to reduce the image retention, e.g. are darker or are black for obtaining off-pixels;
b) means for sequentially switching the position of the pixels driven by different values to reduce the image retention, e.g. the darker or black or off-pixels over the plurality of pixels comprised by the display.

Preferably the control unit may be adapted to so that the means for setting, does the setting of the portion in dependence on the type of content being displayed. The control unit may be adapted to so that the means for setting, depending on the type of content being displayed, includes setting depending upon dominantly dynamic or static image content.

The control unit may be adapted to soften the edges in an image on the display by applying a softening algorithm on a plurality of pixels of the display. The softening algorithm is preferably applied to edges in the image that are static for more than 10 seconds. The control unit may be adapted so that the setting of the portion out of the plurality of pixels to second image values includes the portion being a regular matrix of pixels within at least an area of the display.

Preferably, the means for setting applies a defective pixel correction algorithm to make the pixels driven by different values to reduce the image retention, e.g. the darker or black or off-pixels less visible or invisible to a user in addition to reducing the resolution of the display to a predefined value by setting some pixels to values useful for image retention curing. This is done after a number of operations or after each operation of the means for sequentially switching the position of the pixels driven by different values to reduce the image retention, e.g. the darker or black or off-pixels over the plurality of pixels comprised by the display.

Preferably the means for sequentially setting changes, e.g. translates, rotates, expands, orbits etc. the position of the pixels driven by different values to reduce the image retention, e.g. the darker or black or off-pixels at a predefined or dynamically set frequency or frequencies. This frequency or frequencies preferably corresponds or correspond to a low frequency adapted for reducing at least one of image retention, image sticking and image burn-in.

Optionally the means for sequentially setting applies a randomized algorithm on the off-pixels.

The control unit may be adapted to change pixel values to those useful for image retention curing by fading in and fading out of pixel values over a time period of at least 1 second or more preferably of at least 3 seconds. The fading in and fading out of pixel values can be over a time period of less than 60 seconds, for example. The start time and/or duration of the fading in or fading out can be varied over the image, e.g. to remain within the envelope of times greater than 1 second or more preferably 3 to 60 seconds. For example, the start time and/or duration of the fading in or fading out can be varied randomly over the image.

Any of the functionality of the control unit may be implemented as hardware, computer software, or combinations of both. The calculator may be implemented with a general purpose processor, a digital signal processor (DSP), an application specific integrated circuit (ASIC), a field programmable gate array (FPGA) or other programmable logic device, discrete gate or transistor logic, discrete hardware components, or any combination designed to perform the functions described herein. A general purpose processor may be a microprocessor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The present invention also includes a computer program product comprising code segments adapted for execution on any type of computing device, e.g. for use in a control unit of a display such as one of a liquid crystal display, a plasma display, an organic light emitting diode display and a cathode ray tube display, any of which comprises a plurality of pixels. Software code in the computer program product, when executed on a computing device provides:

means for setting a portion out of the plurality of pixels to different values to reduce the image retention, e.g. to set the darker or black or off-pixels;
means for sequentially switching the position of the pixels driven by different values to reduce the image retention, e.g. the darker or black or off-pixels over the plurality of pixels comprised by the display.

The software code, when executed, may be adapted to so that the means for setting, does the setting in dependence on the type of content being displayed, e.g. includes setting depending upon dominantly dynamic or static image content.

The software code, when executed, may be adapted to soften edges in the image on the display by applying a softening algorithm on a plurality of pixels of the display. The softening algorithm is preferably applied to edges in the image that are static for more than 10 seconds. The control unit may be adapted so that the setting of the portion out of the plurality of pixels to second image values includes the portion being a regular matrix of pixels within at least an area of the display.

Preferably, the software code, when executed applies a defective pixel correction algorithm to make the pixels driven by different values to reduce the image retention, e.g. the darker or black or off-pixels less visible or invisible to a user thus reducing the resolution of the display to a predefined value, and sequentially switching the position of the pixels driven by different values to reduce the image retention, e.g. the darker or black or off-pixels over the plurality of pixels comprised by the display.

Preferably, the software code, when executed, performs the sequentially setting by changing, e.g. translating, expanding, rotating, orbiting etc. the position of the pixels driven by different values to reduce the image retention, e.g. the darker or black or off-pixels. This may be at a predefined frequency or frequencies or at a dynamically set frequency or frequencies. This frequency or frequencies preferably corresponds to a low frequency adapted for reducing at least one of image retention, image sticking and image burn-in.

Optionally the software code, when executed, applies a randomized algorithm on the off-pixels.

Preferably, the software code, when executed, is adapted to change pixel values to those useful for image retention curing by fading in and fading out of pixel values over a time period of at least 1 second or more preferably of at least 3 seconds. The fading in and fading out of pixel values can be over a time period of less than 60 seconds, for example. The start time and/or duration of the fading in or fading out can be varied over the image, e.g. to remain within the envelope of times greater than 1 second or of 3 to 60 seconds. For example, the start time and/or duration of the fading in or fading out can be varied randomly over the image.

The software may be stored in the form of a computer program product on a machine readable signal medium such as a diskette, a solid state memory such as a USB memory stick or RAM, a hard drive, a tape storage means, an optical disk such as a CD-ROM, or DVD or any other suitable digital storage means.

Other variations to the disclosed embodiments can be understood and effected by those skilled in the art in practicing the claimed invention, from a study of the drawings, the disclosure, and the appended claims. For example a display may have a certain first resolution, e.g. of 1920×1080 16:9. All pixels are split in two, this generating 2 half rectangular pixels (above or next to each other) forming together a new square pixel. This results in a display with 3840×1080 or 1920×2160 pixels, but still in 16:9 format (not taking RGB subpixels into account). An image retention reduction technique is applied in accordance with embodiments of the present invention, e.g. in 50% mode for the pixels with a different value, e.g. darker or black, and each rectangular pixel alternative is used 50% of the time. No intended resolution is lost as the resolution of the display is doubled and the halved to return to 1920×1080. Preferably two vertically arranged rectangular pixel halves are used because image retention passes horizontally.

The mere fact that certain measures are recited in mutually different dependent claims does not indicate that a combination of these measures cannot be used to advantage. A single unit may fulfil the functions of several items recited in the claims. Any reference signs in the claims should not be construed as limiting the scope.

1-15. (canceled)

16. A method for processing an image suitable for a display comprising a plurality of pixels, with first image values being definable for the plurality of pixels to display an arbitrary image, the method comprising the steps:
a) setting, depending on the type of content being displayed, a portion out of the plurality of pixels to second image values that are lower than the first image values, that is the second image values are different values to reduce the image retention, the second image values being darker or black for obtaining off-pixels;
b) altering the contents of pixels in the neighbourhood of pixels whose first image values have been set to the second image values in such a way that this altering will reduce the visibility of the pixels driven with different values for the human visual system; and
c) sequentially switching the position of the pixels driven by different values to reduce the image retention over the plurality of pixels comprised by the display.

17. A method according to claim 16, wherein the setting, depending on the type of content being displayed, includes setting depending upon dominantly dynamic or static image content.

18. A method according to claim 16, further softening edges in the image on the display in step b) by applying a softening algorithm on a plurality of pixels of the image.

19. A method according to claim 18, wherein the softening algorithm is applied to edges in the image that are static for more than 10 seconds.

20. A method according to claim 16, wherein setting the portion out of the plurality of pixels to second image values includes the portion being a regular matrix of pixels within at least an area of the display.

21. A method according to claim 16, wherein step a) includes applying a defective pixel correction algorithm to make the pixels driven by different values to reduce the image retention less visible or not visible to a user, and repeating step b).

22. A method according to claim 16, wherein step b) corresponds to changing the position of the pixels driven by different values to reduce the image retention.

23. A method according to claim 22, wherein the changing the position is by fading in and fading out of pixel values over a time period of at least 1 second or at least 3 seconds.

24. A method according to claim 23, wherein the fading in and fading out of pixel values is over a time period of less than 60 seconds

25. A method according to claim 16, wherein step b) is performed by applying a randomized algorithm on the pixels driven by different values to reduce the image retention.

26. A method according to claim 16, wherein the display corresponds to one of a liquid crystal display, a plasma display, an organic light emitting diode display and a cathode ray tube display.

27. A method according to claim 16, wherein the method is used at a receiver side arranged inside a display and/or at an image generator side.

28. A display comprising a panel, a light source device for illuminating the panel, a driving unit driving the panel and the light source device, and a control unit controlling the driving unit, wherein the control unit is arranged to set, depending upon the image content, a portion out of a plurality of pixels to different values to reduce the image retention, that is to set pixels to dark or black for obtaining off-pixels and to alter the contents of pixels in the neighbourhood of pixels whose values have been set to different values in such a way that such altering will reduce the visibility of the pixels driven with different values for the human visual system; and to sequentially switch the position of the pixels driven by different values to reduce the image retention, that is darker or black or off-pixels over the plurality of pixels of which the display is comprised.

29. A computer-readable medium having stored on it a computer program product comprising code segments capable of performing the steps of the method according to claim 16, when executed on a computing device.

30. A control unit for use with a display comprising a plurality of pixels, comprising:
a) means for setting, depending on the content of the image a portion out of the plurality of pixels to different values to reduce the image retention, i.e. to darker or black for obtaining off-pixels;
b) means for altering the contents of pixels in the neighbourhood of pixels whose values have been set to different values in such a way that this altering will reduce the visibility of the pixels driven with different values for the human visual system; and
c) means for sequentially switching the position of the pixels driven by different values to reduce the image retention, i.e. darker or black or off-pixels over the plurality of pixels comprised by the display.

31. The display according to claim 28, wherein the control unit is further adapted to set, depending on the type of content being displayed, in dependence upon dominantly dynamic or static image content.

32. A display according to claim 28, arranged to soften edges in the image on the display by applying a softening algorithm on a plurality of pixels of the image.

33. The display according to claim 28, wherein the portion out of the plurality of pixels to be set to second image values is a regular matrix of pixels within at least an area of the display.

34. The display according to claim 28, wherein the control unit is adapted to apply a defective pixel correction algorithm to make the pixels driven by different values to reduce the image retention less visible or not visible to a user.

35. The display according to claim 28, wherein the control unit is adapted to change the position of the pixels driven by different values to reduce the image retention.
